(19) United States
(12) Patent Application Publication
(10) Pub. No.: US 2008/0232570 A1
(43) Pub. Date: Sep. 25, 2008

(54) Automatic Reconstitution of Telecommunications Sessions

(75) Inventors: Ezra Raphael Gilbert, Highland Park, NJ (US); Vipul Kishore Lalka, Highland Park, NJ (US); Venkat R. Gilakattula, Matawan, NJ (US)

Correspondence Address: Avaya;DEMONT & BREYER, LLC, 100 COMMONS WAY, STE 250, HOLMDEL, NJ, 07733, US

(73) Assignee: AVAYA TECHNOLOGY LLC, Basking Ridge, NJ (US)

(21) Appl. No.: 11/688,741

(22) Filed: Mar. 20, 2007

(51) Int. Cl. H04M 3/42

(52) U.S. Cl. 379/204.01

(57) ABSTRACT

A telecommunications feature is disclosed that enables a person to disconnect from a telecommunications session (e.g., a telephone call, a chat session, a video conference, etc.) and to be automatically reconnected at a later time. For example, Fred might be required to participate in his project group's weekly conference call, but as a practical matter Fred really only need to participate at the beginning and end of the meeting. After the conference call begins and Fred learns that the meeting will end at 4:00 PM, Fred uses the present invention to program his telephone to disconnect from the conference call now and to automatically reconnect to the conference call at 3:45 PM. This gives Fred the opportunity to get some work done and yet not miss the end of the conference call.

### FIELD OF THE INVENTION

The present invention relates to telecommunications in general, and, more particularly, to a novel feature in a telecommunications system.

### BACKGROUND OF THE INVENTION

The need exists for new features that make using telephones and other communications devices easier to use.

### SUMMARY OF THE INVENTION

The present invention is a new and nonobvious telecommunications feature that is advantageous over telecommunications systems in the prior art. The present invention is colloquially called “telephony snooze” because it enables a person to disconnect from a telecommunications session (e.g., a telephone call, a chat session, a video conference, etc.) and to be automatically reconnected at a later time. For example, Fred might be required to participate in his project group's weekly conference call, but as a practical matter Fred really only need to participate at the beginning and end of the meeting. After the conference call begins and Fred learns that the meeting will end at 4:00 PM, Fred uses the present invention to program his telephone to disconnect from the conference call now and to automatically reconnect to the conference call at 3:45 PM. This gives Fred the opportunity to get some work done and yet not miss the end of the conference call.

Some embodiments of the present invention enable a person to disconnect from a telecommunications session and to be automatically reconnected at a later time at a different terminal. For example, if in the above example Fred expects to be a home at 3:45 PM, he can use the present invention to program his telephone to disconnect from the conference call now and to automatically reconnect his home telephone to the conference call at 3:45 PM.

The illustrative embodiment comprises a method comprising: (1) establishing a first bi-directional communications session between a first telecommunications terminal and a second telecommunications terminal; (2) receiving at said first telecommunications terminal a reconnection parameter for a reconnection test; (3) terminating said first bi-directional communications session between said first telecommunications terminal and said second telecommunications terminal; and (4) establishing a second bi-directional communications session between said first telecommunications terminal and a third telecommunications terminal when said first telecommunications terminal determines that said reconnection test is satisfied; wherein said reconnection test comprises comparing said reconnection parameter to a time-varying parameter.

### BRIEF DESCRIPTION OF THE DRAWINGS

FIG. 1 depicts a schematic diagram of the salient components of telecommunications system 100 in accordance with the illustrative embodiment of the present invention.

FIG. 2 depicts a block diagram of the salient components of switch 102 in accordance with the illustrative embodiment of the present invention.

FIG. 3 depicts a block diagram of the salient components of telecommunications terminals 101-i in accordance with the illustrative embodiment of the present invention.

FIG. 4 depicts a flowchart of the salient tasks performed by the first illustrative embodiment of the present invention.

FIG. 5 depicts a flowchart of the salient tasks performed by the second illustrative embodiment of the present invention.

FIG. 6 depicts a flowchart of the salient tasks performed by the third illustrative embodiment of the present invention.

FIG. 7 depicts a flowchart of the salient tasks performed by the fourth illustrative embodiment of the present invention.

FIG. 8 depicts a flowchart of the salient tasks performed by the fifth illustrative embodiment of the present invention.

### DETAILED DESCRIPTION

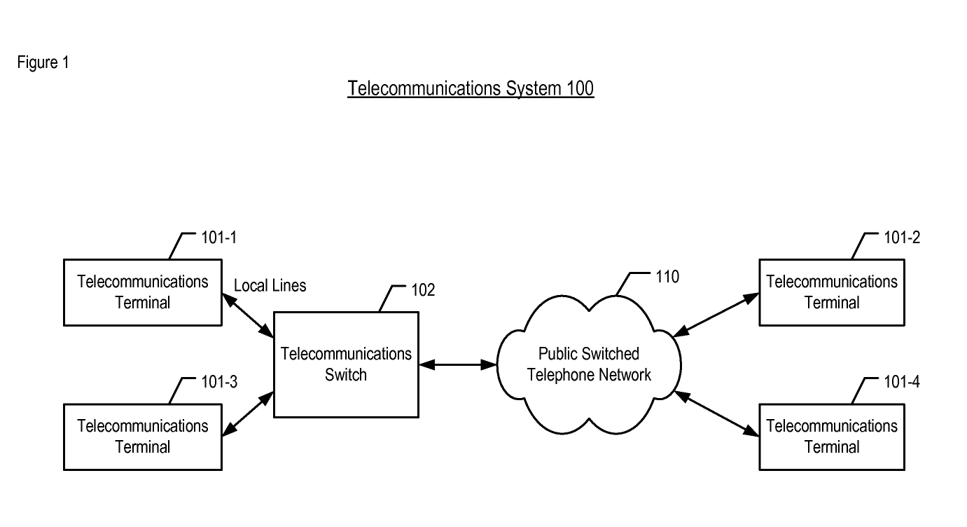

FIG. 1 depicts a schematic diagram of the salient components of telecommunications system 100 in accordance with the illustrative embodiment of the present invention. Telecommunications system 100 comprises: telecommunications terminals 101-1, 101-2, 101-3, and 101-4, telecommunications switch 102, and Public Switched Telephone Network 110, interconnected as shown

Although the illustrative embodiment comprises one switch, it will be clear to those skilled in the art, after reading this disclosure, how to make and use alternative embodiments of the present invention that comprise any number of switches. Furthermore, although the illustrative embodiment comprises four telecommunications terminals, it will be clear to those skilled in the art, after reading this disclosure, how to make and use embodiments of the present invention that comprise any number of telecommunications terminals. And still furthermore, although two of the terminals are connected directly to switch 102 and two of the terminals are connected indirectly to switch 102 via the Public Switched Telephone Network, it will be clear to those skilled in the art, after reading this disclosure, how to make and use alternative embodiments of the present invention in which any number of the terminals are connected directly or indirectly, through the Public Switched Telephone Network, the Internet, and/or another network.

In accordance with the illustrative embodiment, telecommunications terminal 101-i, wherein iε{1, 2, 3, 4}, is a device that is capable of performing the functionality described below and in the accompanying figures. In particular, telecommunications terminal 101-i provides “bi-directional communications sessions,” such as, for instance and without limitation, conventional telephone calls. Additionally, it will be clear to those skilled in the art, after reading this disclosure, how to make and use alternative embodiments of the present invention in which telecommunications terminal 101-i provides:
i. bi-directional audio (e.g. VOIP, DSO, ISDN, etc.), or
ii. bi-directional data, such as, for instance and without limitation, interactive text chat, or
iii. bi-directional video, such as, for instance and without limitation, video conferencing, or
iv. uni-directional video (e.g., videocasting, etc.) combined with bi-directional audio, or
v. uni-directional video combined with bi-directional data, or
vi. uni-directional data (e.g., push based file transfer, non-interactive graphics, etc.) combined with bi-directional audio, or
vii. any combination of i, ii, iii, iv, v, and vi.
   The details of how to make and use telecommunications terminal 101-i are provided in detail below and in the accompanying drawings.

In accordance with the illustrative embodiment, switch 102 is a private branch exchange that is capable of performing the functionality described below and in the accompanying drawings. In particular, switch 102 provides connectivity between one or more local telecommunications terminals via local telecommunications lines. Switch 102 also facilitates bi-directional communications sessions involving both local terminals and the Public Switched Telephone Network, via one or more trunk lines. It will be clear to those skilled in the art after reading this disclosure how to make and use switch 102.

In accordance with the illustrative embodiment, Public Switched Telephone Network 110 is the public telephone network. It will be clear to those skilled in the art how to make and use Public Switched Telephone Network 110.

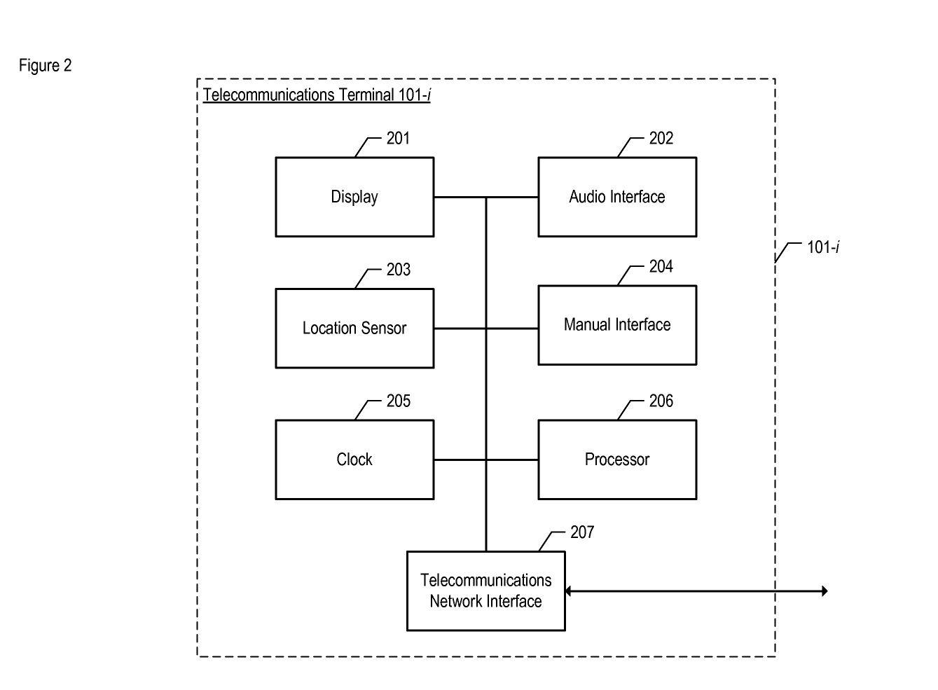

FIG. 2 is a block diagram of the salient components of telecommunications terminal 101-i in accordance with the illustrative embodiment of the present invention, which are interrelated as shown. In accordance with the illustrative embodiment, telecommunications terminal 101-i comprises:

i. display 201, and

ii. audio interface 202, and

iii. location sensor 203, and

iv. manual interface 204, and

v. clock 205, and

vi. processor 206, and

vii. telecommunications network interface 207.

It will be clear to those skilled in the art, after reading this disclosure, how to make and use alternative embodiments of the present invention in which telecommunications terminal 101-i comprises any subcombination of i, ii, iii, iv, v, vi, and vii. For example and without limitation, possible embodiments of telecommunications terminal 101-i are: a mobile telephone, a desktop computer, a speakerphone, a videoconferencing system, etc.

Display 201 is a liquid crystal display that presents the user of telecommunications terminal 101-i with a visual representation of data, in well known fashion. It will be clear to those skilled in the art how to make and use alternative embodiments of the present invention in which display 201 is other than a liquid crystal display.

Audio interface 202 is a speaker that outputs sound to the user and a microphone that inputs sound from the user. It will be clear to those skilled in the art how to make and use audio interface 202.

Location sensor 203 is a Global Positioning System (GPS) receiver that is capable of determining the location of telecommunications terminal 101-i in well known fashion. It will be clear to those skilled in the art how to make and use alternative embodiments of the present invention in which location sensor 203 is another means of determining the location—or changes in the location—of telecommunications terminal 101-i.

Manual interface 204 is an arrangement of tactile switches which allow the user of terminal 101-i to enter data and commands in well known fashion. It will be clear to those skilled in the art how to make and use alternative embodiments of the present invention in which manual interface 204 comprises another data entry mechanism, such as a touch screen.

Clock 205 is a quartz oscillator providing regular electrical signals to enable the accurate determination of calendrical and elapsed time in well known fashion. It will be clear to those skilled in the art, after reading this disclosure, how to make and use embodiments of the present invention in which the determination of time is accomplished by some other mechanism (e.g. communication with a remote time server, a software timing loop, etc.).

Processor 206 is a microprocessor that supervises the operation of tasks performed by telecommunication terminal 101-i in well known fashion. It will clear to those skilled in the art, after reading this disclosure, how to make and use processor 206. Details of tasks performed by processor 206 in carrying out the method of the present invention are provided below and in the accompanying drawings.

Telecommunications network interface 207 is a wireless interface to the public switched telephone network allowing for the placement of calls to and from terminal 101-i in well known fashion. It will be clear to those skilled in the art, after reading this disclosure, how to make and use alternative embodiments of the present invention in which telecommunications network interface allows for connection to some other, or multiple, telecommunications networks with or without the use of physical connections.

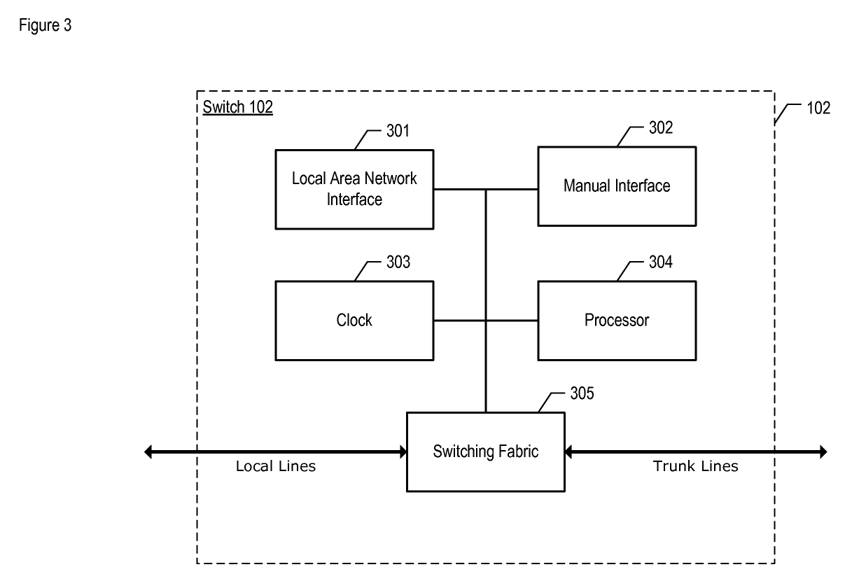

FIG. 3 depicts a block diagram of the salient components of switch 102 in accordance with the illustrative embodiment of the present invention, which are interrelated as shown. In accordance with the illustrative embodiment, switch 102 comprises:

i. local area network interface 201, and

ii. manual interface 202, and

iii. clock 203, and

iv. processor 204, and

v. switching fabric 205.

It will be clear to those skilled in the art, after reading this disclosure, how to make and use alternative embodiments of the present invention in which telecommunications terminal 101-i comprises any subcombination of i, ii, iii, iv, and v.

Local area network interface 301 is an Ethernet interface allowing for data connectivity between switch 102 and other data processing equipment such as computers and data storage devices. It will be clear to those skilled in the art, after reading this disclosure, how to make and use local area network interface 301.

Manual interface 302 is a collection of pushbutton switches which allow the user of switch 102 to enter data and commands in well known fashion. It will be clear to those skilled in the art how to make and use manual interface 302.

Clock 303 is a quartz oscillator providing regular electrical signals enabling the accurate determination of calendrical and elapsed time in well known fashion. It will be clear to those skilled in the art, after reading this disclosure, how to make and use embodiments of the present invention in which the determination of time is accomplished by some other mechanism (e.g. communication with a remote time server, a software timing loop, etc.)

Processor 304 is a microprocessor that orchestrates the operation switch 102 as described below and in the accompanying figures. It will clear to those skilled in the art, after reading this disclosure, how to make and use processor 304.

Switching fabric 305 is a backplane switch that provides the ability to connect local and trunk lines in well known fashion. It will be clear to those skilled in the art how to make and use switching fabric 305.

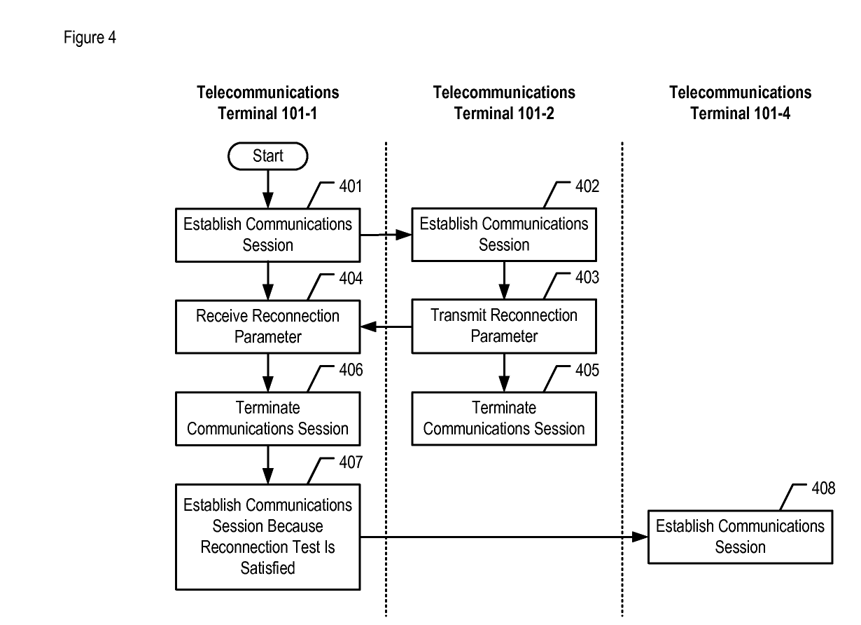

FIG. 4 depicts a flowchart of the salient tasks performed in accordance with the first illustrative embodiment of the present invention. It will be clear to those skilled in the art, after reading this disclosure, which tasks depicted in FIG. 4 can be performed concurrently or in a different order than that depicted.

At task 401, telecommunications terminal 101-1 begins the process of establishing a first bi-directional communications session with telecommunications terminal 101-2.

At task 402, telecommunications terminal 101-2 completes the process of establishing the first bi-directional communications session with telecommunications terminal 101-2. It will be clear to those skilled in the art, after reading this disclosure, how to make and use alternative embodiments of the present invention in which the first bi-directional communications session is initiated by telecommunications terminal 101-2 and completed by telecommunications terminal 101-1.

At task 403, telecommunications terminal 101-2 transmits:

(i) a reconnection parameter, and

(ii) the telephone number of telecommunications terminal 101-4

to telecommunications terminal 101-1. In accordance with the illustrative embodiment of the present invention, the reconnection parameter and the telephone number of telecommunications terminal 101-4 are given to telecommunications terminal 101-2 by the user of telecommunications terminal 101-2.

For the purposes of this specification, the “reconnection parameter” is defined as the circumstances in which a bi-directional communications session is to be established, re-established, or joined. In accordance with the illustrative embodiment, the reconnection parameter is a calendrical time, but it will be clear to those skilled in the art that in some other embodiments it is a specification of that event. It will be clear to those skilled in the art, after reading this disclosure, how to make and use alternative embodiments of the present invention in which the reconnection parameter is transmitted by device other than telecommunications terminal 101-1.

At task 404, telecommunications terminal 101-1 receives

(i) the reconnection parameter, and

(ii) the telephone number of telecommunications terminal 101-4.

At task 405, telecommunications terminal 101-2 terminates the first bi-directional communications session.

At task 406, telecommunications terminal 101-1 terminates the first bi-directional communications session.

At task 407, telecommunications terminal 101-1 determines that the reconnection test is satisfied in accordance with the reconnection parameter and begins the process of establishing a second communications session with telecommunication terminal 101-4.

At task 408, telecommunications terminal 101-4 completes the process of establishing the second bi-directional communications session with telecommunications terminal 101-2.

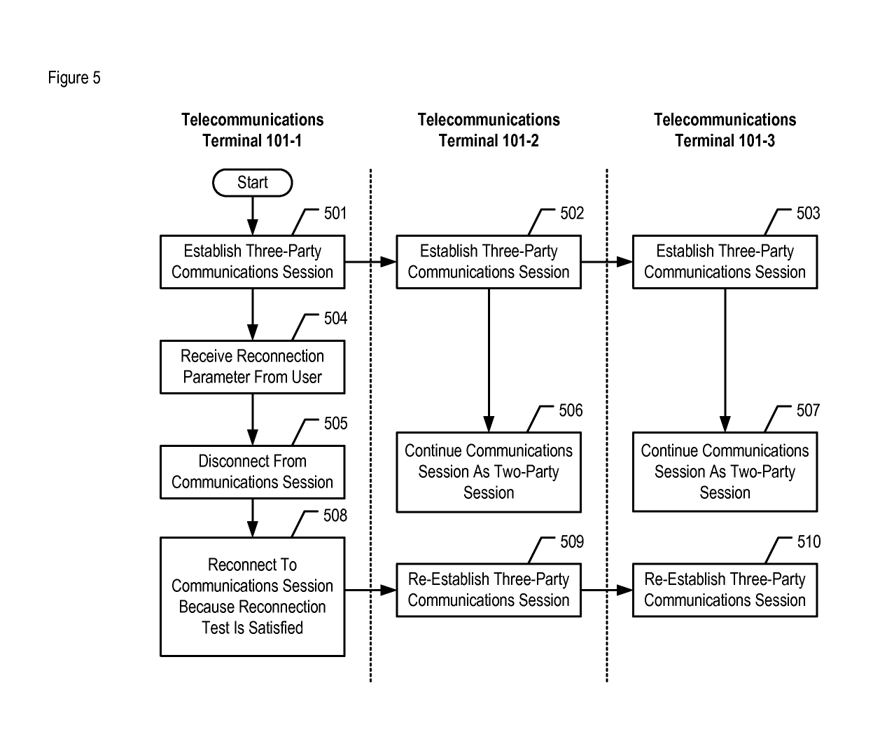

FIG. 5 depicts a flowchart of the salient tasks performed in accordance with the second illustrative embodiment of the present invention, which involves a conference call.

At task 501, telecommunications terminal 101-1 begins the process of establishing a three-party bi-directional communications session with telecommunications terminal 101-2 and telecommunications terminal 101-3. It will be clear to those skilled in the art, after reading this disclosure, how to make and use alternative embodiments of the present invention in which the three-party bi-directional communications session is initiated by:

(i) telecommunications terminal 101-1, or

(ii) telecommunications terminal 101-2, or

(iii) telecommunications terminal 101-3, or

(iv) any two of i, ii, and iii.

At task 502, telecommunications terminal 101-2 completes the process of establishing the three-party bi-directional communications session with telecommunications terminal 101-1 and telecommunications terminal 101-3.

At task 503, telecommunications terminal 101-3 completes the process of establishing the three-party bi-directional communications session with telecommunications terminal 101-1 and telecommunications terminal 101-2.

At task 504, telecommunications terminal 101-1 receives

(i) the reconnection parameter, and

(ii) the telephone number of telecommunications terminal 101-2

from the user of telecommunications terminal 101-1.

At task 505, telecommunications terminal 101-1 disconnects from the three-party bi-directional communications session, while telecommunications terminal 101-2 and telecommunications terminal 101-3 continue with the bi-directional communications session as two-party call.

At task 506, telecommunications terminal 101-2 continues the bi-directional communications session as a two-party call with telecommunications terminal 101-3 after telecommunications terminal 101-1 drops out.

At task 507, telecommunications terminal 101-3 continues the bi-directional communications session as a two-party call with telecommunications terminal 101-2 after telecommunications terminal 101-1 drops out.

At task 508, telecommunications terminal 101-1 determines that the reconnection test is satisfied in accordance with the reconnection parameter and begins the process of joining the bi-directional communications session with telecommunications terminal 101-2 and telecommunications terminal 101-3 to reconstitute it as a three-way call.

At task 509, telecommunications terminal 101-2 completes the process of adding telecommunications terminal 101-1 to the bi-directional communications session to reconstitute it as a three-way call.

At task 510, telecommunications terminal 101-3 completes the process of adding telecommunications terminal 101-1 to the bi-directional communications session to reconstitute it as a three-way call.

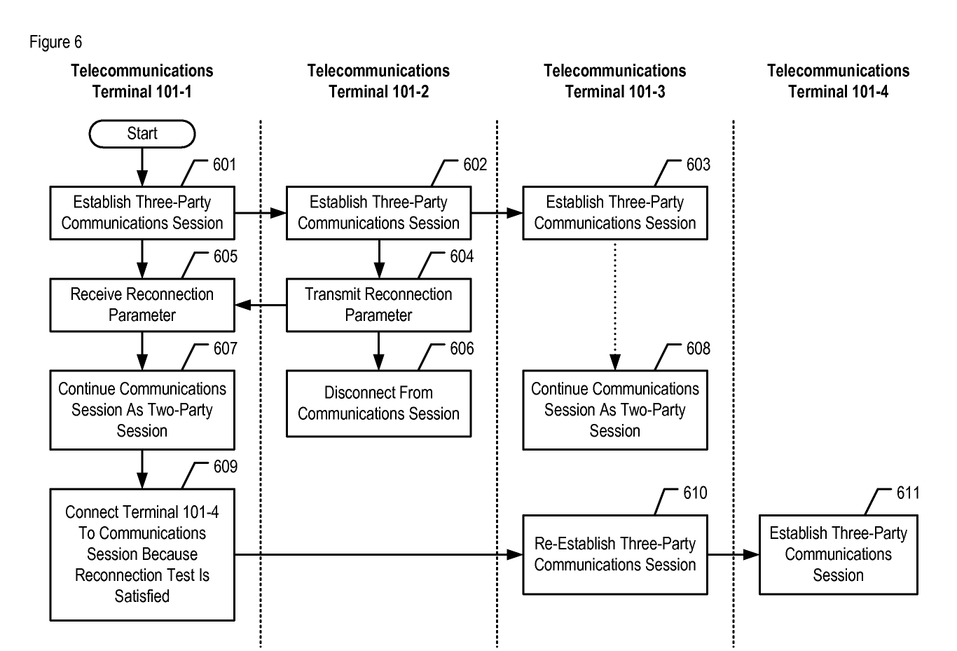

FIG. 6 depicts a flowchart of the salient tasks performed in accordance with the third illustrative embodiment of the present invention, which involves a conference call.

At task 601, telecommunications terminal 101-1 begins the process of establishing a three-party bi-directional communications session with telecommunications terminal 101-2 and telecommunications terminal 101-3. It will be clear to those skilled in the art, after reading this disclosure, how to make and use alternative embodiments of the present invention in which the three-party bi-directional communications session is initiated by:

(i) telecommunications terminal 101-1, or

(ii) telecommunications terminal 101-2, or

(iii) telecommunications terminal 101-3, or

(iv) any two of i, ii, and iii.

At task 602, telecommunications terminal 101-2 completes the process of establishing the three-party bi-directional communications session with telecommunications terminal 101-1 and telecommunications terminal 101-3.

At task 603, telecommunications terminal 101-3 completes the process of establishing the three-party bi-directional communications session with telecommunications terminal 101-1 and telecommunications terminal 101-2.

At task 604, telecommunications terminal 101-2 transmits:

(i) a reconnection parameter, and

(ii) the telephone number of telecommunications terminal 101-4

to telecommunications terminal 101-1.

At task 605, telecommunications terminal 101-1 receives

(i) the reconnection parameter, and

(ii) the telephone number of telecommunications terminal 101-4.

At task 606, telecommunications terminal 101-2 disconnects from the three-party bi-directional communications session, while telecommunications terminal 101-1 and telecommunications terminal 101-3 continue with the bi-directional communications session as two-party call.

At task 607, telecommunications terminal 101-1 continues the bi-directional communications session as a two-party call with telecommunications terminal 101-3 after telecommunications terminal 101-2 disconnects.

At task 608, telecommunications terminal 101-3 continues the bi-directional communications session as a two-party call with telecommunications terminal 101-1 after telecommunications terminal 101-2 disconnects.

At task 609, telecommunications terminal 101-1 determines that the reconnection test is satisfied in accordance with the reconnection parameter and begins the process of adding telecommunications terminal 101-4 to the bi-directional communications session to create a three-way call.

At task 610, telecommunications terminal 101-3 completes the process of connecting telecommunications terminal 101-4 to the bi-directional communications session to reconstitute it as a three-way call.

At task 611, telecommunications terminal 101-4 completes the process of connecting to the bi-directional communications session to reconstitute it as a three-way call.

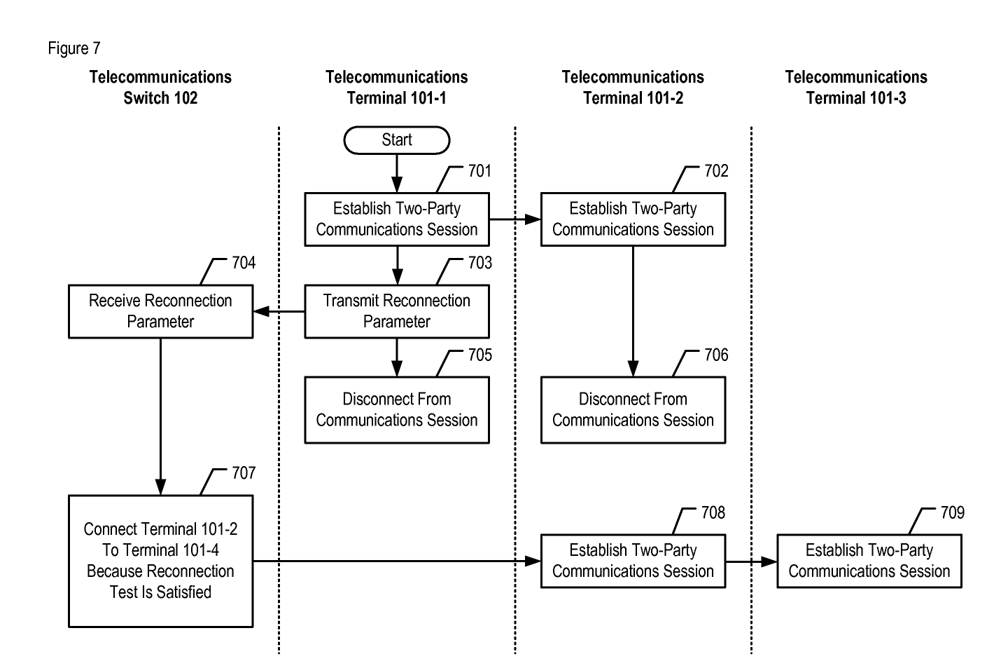

FIG. 7 depicts a flowchart of the salient tasks performed in accordance with the fourth illustrative embodiment of the present invention. It will be clear to those skilled in the art, after reading this disclosure, which tasks depicted in FIG. 7 can be performed concurrently or in a different order than that depicted.

At task 701, telecommunications terminal 101-1 begins the process of establishing a first bi-directional communications session with telecommunications terminal 101-2.

At task 702, telecommunications terminal 101-2 completes the process of establishing the first bi-directional communications session with telecommunications terminal 101-1. It will be clear to those skilled in the art, after reading this disclosure, how to make and use alternative embodiments of the present invention in which the first bi-directional communications session is initiated by telecommunications terminal 101-2 and completed by telecommunications terminal 101-1.

At task 703, telecommunications terminal 101-2 transmits:

(i) a reconnection parameter, and

(ii) the telephone number of telecommunications terminal 101-3

to telecommunications switch 102. In accordance with the illustrative embodiment of the present invention, the reconnection parameter and the telephone number of telecommunications terminal 101-3 are given to telecommunications terminal 101-1 by the user of telecommunications terminal 101-1.

At task 704, telecommunications switch 102 receives

(i) the reconnection parameter, and

(ii) the telephone number of telecommunications terminal 101-1.

At task 705, telecommunications terminal 101-1 terminates the first bi-directional communications session.

At task 706, telecommunications terminal 101-2 terminates the first bi-directional communications session.

At task 707, telecommunications switch 102 determines that the reconnection test is satisfied in accordance with the reconnection parameter and begins the process of establishing a second communications session with telecommunication terminal 101-2 and telecommunications terminal 101-3.

At task 708, telecommunications terminal 101-2 completes the process of establishing the second bi-directional communications session with telecommunications terminal 101-3.

At task 709, telecommunications terminal 101-3 completes the process of establishing the second bi-directional communications session with telecommunications terminal 101-2.

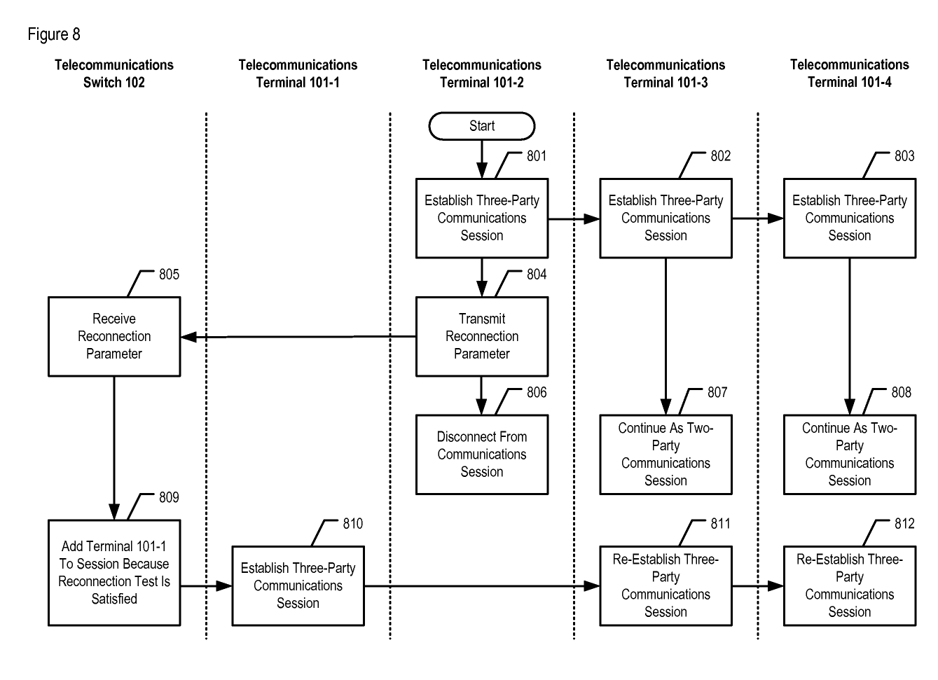

FIG. 8 depicts a flowchart of the salient tasks performed in accordance with the fifth illustrative embodiment of the present invention. It will be clear to those skilled in the art, after reading this disclosure, which tasks depicted in FIG. 8 can be performed concurrently or in a different order than that depicted.

At task 801, telecommunications terminal 101-2 begins the process of establishing a three-party bi-directional communications session with telecommunications terminal 101-3 and telecommunications terminal 101-4.

At task 802, telecommunications terminal 101-3 completes the process of establishing the three-party bi-directional communications session with telecommunications terminal 101-2 and telecommunications terminal 101-4. It will be clear to those skilled in the art, after reading this disclosure, how to make and use alternative embodiments of the present invention in which the three-party bi-directional communications session is initiated by telecommunications terminal 101-3 or telecommunications terminal 101-4.

At task 803, telecommunications terminal 101-4 completes the process of establishing the three-party bi-directional communications session with telecommunications terminal 101-2 and telecommunications terminal 101-3.

At task 804, telecommunications terminal 101-2 transmits:

(i) a reconnection parameter, and

(ii) the telephone number of telecommunications terminal 101-1

to telecommunications switch 102. In accordance with the illustrative embodiment of the present invention, the reconnection parameter and the telephone number of telecommunications terminal 101-1 are given to telecommunications terminal 101-2 by the user of telecommunications terminal 101-2.

At task 805, telecommunications switch 102 receives

(i) the reconnection parameter, and

(ii) the telephone number of telecommunications terminal 101-2.

At task 806, telecommunications terminal 101-2 disconnects from the three-party bi-directional communications session.

At task 806, telecommunications terminal 101-2 terminates the three-party bi-directional communications session.

At task 807, telecommunications terminal 101-3 continues the bi-directional communications session as a two-party session with telecommunications terminal 101-4.

At task 808, telecommunications terminal 101-4 continues the bi-directional communications session as a two-party session with telecommunications terminal 101-3.

At task 809, telecommunications switch 102 determines that the reconnection test is satisfied in accordance with the reconnection parameter and begins the process of adding telecommunications terminal 101-1 to the communications session with telecommunication terminal 101-3 and telecommunications terminal 101-4 to re-establish a three-party communications session.

At task 810, telecommunications terminal 101-1 completes the process of establishing the three-party bi-directional communications session with telecommunications terminal 101-3 and telecommunications terminal 101-4.

At task 811, telecommunications terminal 101-3 completes the process of establishing the three-party bi-directional communications session with telecommunications terminal 101-1 and telecommunications terminal 101-4.

At task 812, telecommunications terminal 101-4 completes the process of establishing the three-party bi-directional communications session with telecommunications terminal 101-1 and telecommunications terminal 101-3.

It is to be understood that the disclosure only teaches several examples of the illustrative embodiments and that many variations of the invention can easily be devised by those skilled in the art after reading this disclosure and that the scope of the present invention is to be determined by the following claims.

What is claimed is:

1. A method comprising:
(1) establishing a first bi-directional communications session between a first telecommunications terminal and a second telecommunications terminal;
(2) receiving at said first telecommunications terminal a reconnection parameter for a reconnection test;
(3) terminating said first bi-directional communications session between said first telecommunications terminal and said second telecommunications terminal; and
(4) establishing a second bi-directional communications session between said first telecommunications terminal and a third telecommunications terminal when said first telecommunications terminal determines that said reconnection test is satisfied;
wherein said reconnection test comprises comparing said reconnection parameter to a time-varying parameter.

2. The method of claim 1 wherein said reconnection parameter is received at said first telecommunications terminal from a user of said first telecommunications terminal.

3. The method of claim 1 wherein said reconnection parameter is received at said first telecommunications terminal from said second telecommunications terminal.

4. The method of claim 1 wherein said reconnection parameter is a calendrical time.

5. The method of claim 1 wherein said reconnection parameter is a specification of an event.

6. The method of claim 1 wherein said second telecommunications terminal and said third telecommunications terminal are the same.

7. The method of claim 1 wherein said second telecommunications terminal and said third telecommunications terminal are different.

8. A method comprising:
(1) establishing a bi-directional communications session among a first telecommunications terminal, a second telecommunications terminal, and a third telecommunications terminal;
(2) receiving at said first telecommunications terminal a reconnection parameter for a reconnection test;
(3) disconnecting said first telecommunications terminal from said bi-directional communications session, wherein said first telecommunications terminal and said second telecommunications terminal continue with said bi-directional communications session; and
(4) reconnecting said first telecommunications terminal to said bi-directional communications session when said first telecommunications terminal determines that said reconnection test is satisfied;
wherein said reconnection test comprises comparing said reconnection parameter to a time-varying parameter.

9. The method of claim 8 wherein said reconnection parameter is received at said first telecommunications terminal from a user of said first telecommunications terminal.

10. The method of claim 8 wherein said reconnection parameter is received at said first telecommunications terminal from said second telecommunications terminal.

11. The method of claim 8 wherein said reconnection parameter is a calendrical time.

12. The method of claim 8 wherein said reconnection parameter is a specification of an event.

13. A method comprising:
(1) establishing a bi-directional communications session among a first telecommunications terminal, a second telecommunications terminal, and a third telecommunications terminal;
(2) receiving at said first telecommunications terminal a reconnection parameter for a reconnection test;
(3) disconnecting said third telecommunications terminal from said bi-directional communications session, wherein said first telecommunications terminal and said second telecommunications terminal continue with said bi-directional communications session; and
(4) connecting a fourth telecommunications terminal to said bi-directional communications session when said first telecommunications terminal determines that said reconnection test is satisfied;
wherein said reconnection test comprises comparing said reconnection parameter to a time-varying parameter.

14. The method of claim 13 wherein said reconnection parameter is received at said first telecommunications terminal from a user of said first telecommunications terminal.

15. The method of claim 13 wherein said reconnection parameter is received at said first telecommunications terminal from said third telecommunications terminal.

16. The method of claim 13 wherein said reconnection parameter is a calendrical time.

17. The method of claim 13 wherein said reconnection parameter is a specification of an event.

18. The method of claim 13 wherein said third telecommunications terminal and said fourth telecommunications terminal are the same.

19. The method of claim 13 wherein said third telecommunications terminal and said fourth telecommunications terminal are different.

20. A method comprising:
(1) establishing a bi-directional communications session between a first telecommunications terminal and a second telecommunications terminal through a switch;
(2) receiving at said switch a reconnection parameter for a reconnection test;
(3) terminating said bi-directional communications session between said first telecommunications terminal and said second telecommunications terminal; and
(4) establishing a second bi-directional communications session between said first telecommunications terminal and a third telecommunications terminal when said switch determines that said reconnection test is satisfied;
wherein said reconnection test comprises comparing said reconnection parameter to a time-varying parameter.

21. The method of claim 20 wherein said reconnection parameter is received at said switch from said first telecommunications terminal.

22. The method of claim 20 wherein said reconnection parameter is a calendrical time.

23. The method of claim 20 wherein said reconnection parameter is a specification of an event.

24. The method of claim 20 wherein said second telecommunications terminal and said third telecommunications terminal are the same.

25. The method of claim 20 wherein said second telecommunications terminal and said third telecommunications terminal are different.

26. A method comprising:
(1) establishing a bi-directional communications session through a switch, wherein said bi-directional communications session is among a first telecommunications terminal, a second telecommunications terminal, and a third telecommunications terminal;
(2) receiving at said switch a reconnection parameter for a reconnection test;
(3) disconnecting said first telecommunications terminal from said bi-directional communications session; and
(4) connecting a fourth telecommunications terminal to said bi-directional communications session when said switch determines that said reconnection test is satisfied;
wherein said reconnection test comprises comparing said reconnection parameter to a time-varying parameter.

27. The method of claim 26 wherein said reconnection parameter is received at said switch from said first telecommunications terminal.

28. The method of claim 26 wherein said reconnection parameter is received at said switch from said second telecommunications terminal.

29. The method of claim 26 wherein said reconnection parameter is a calendrical time.

30. The method of claim 26 wherein said reconnection parameter is a specification of an event.

31. The method of claim 26 wherein said first telecommunications terminal and said fourth telecommunications terminal are the same.

32. The method of claim 26 wherein said first telecommunications terminal and said fourth telecommunications terminal are different.
